(19) United States
(12) Patent Application Publication
(10) Pub. No.: US 2015/0052598 A1
(43) Pub. Date: Feb. 19, 2015

(54) SYSTEM, METHOD, AND COMPUTER PROGRAM PRODUCT FOR TICKET AUTHORIZATION

(71) Applicant: Your Net Works. Inc., San Francisco, CA (US)

(72) Inventors: Miroslav Sarbaev, San Francisco, CA (US); Alexander Gelf, Cupertino, CA (US)

(73) Assignee: Your Net Works, Inc., San Francisco, CA (US)

(21) Appl. No.: 14/363,292

(22) PCT Filed: Dec. 11, 2012
(86) PCT No.: PCT/US2012/069012

§ 371 Date: Jun. 5, 2014

Related U.S. Application Data
(60) Provisional application No. 61/630,490, filed on Dec. 12, 2011.

(51) Int. Cl. H04L 29/06

(52) U.S. Cl. CPC H04L 63/0807
USPC 726/10

(57) ABSTRACT

A system, method, and computer program product are provided for ticket authorization. In use, data stored by an integrated circuit of an integrated circuit card (ICC) is identified. Additionally, it is verified whether the ICC is associated with a valid ticket, based on the data and information stored remotely from the ICC. Further, the ticket is authorized, based on the verification. Still yet, based on the authorization, additional data indicative of the authorization is stored on the ICC.

### FIELD OF THE INVENTION

The present invention relates to tickets, and more particularly to authorizing tickets.

### BACKGROUND

Distributing and validating tickets (e.g. for events) is a logistically complicated process, especially when tickets are distributed by a network of independent resellers and are subsequently validated at various different locations (e.g. the entry to the venue in which the event is held, a store at which the ticket is accepted in exchange for a product, etc.). In the context of an event, fundamentally the ticket is a contract between the organizer of the event and the customer who purchased the ticket that allows the customer to visit the venue for a specific event under terms and conditions published by the venue and by the organizer of the event. In many situations, for example, the ticket gives the ticketholder the right of entry to the event. Terms and conditions may include some restrictions, such as whether the customer would be able to exit and re-enter the venue during the event, what would be the refund process if the event is canceled, etc.

The traditional embodiment of a ticket is a paper card that contains information about the event and the venue. When the patron arrives to the venue he presents the ticket to a ticket collector, the ticket collector performs the visual inspection of a ticket against counterfeiting and then grants access to the venue in exchange for cancelling the ticket, either by tearing it and returning to the customer, or by collecting it from the customer. In this process, (1) All tickets need to be preprinted by the event organizers and distributed to resellers for distribution; and (2) Validation of the tickets is visual and depends on some properties of the ticket, or implicit knowledge of ticket validity.

Since due the abundance of high quality copy equipment tickets can be easily duplicated, event organizers need to protect tickets from copying by using some technology, such as holographic images that cannot be easily duplicated. These limitations and others make the process inflexible and inefficient and not completely immune to duplication or counterfeiting.

There is thus a need for addressing these and/or other issues associated with the prior art.

### SUMMARY

A system, method, and computer program product are provided for ticket authorization. In use, data stored by an integrated circuit of an integrated circuit card (ICC) is identified. Additionally, it is verified whether the ICC is associated with a valid ticket, based on the data and information stored remotely from the ICC. Further, the ticket is authorized, based on the verification. Still yet, based on the authorization, additional data indicative of the authorization is stored on the ICC.

### BRIEF DESCRIPTION OF THE DRAWINGS

FIG. 1 illustrates a network architecture, in accordance with one embodiment.

FIG. 2 illustrates a representative hardware environment that may be associated with the servers and/or clients of FIG. 1, in accordance with one embodiment.

FIG. 3 illustrates a method for ticket authorization, in accordance with one embodiment.

FIG. 4 illustrates a system for event ticket authorization, in accordance with another embodiment.

FIG. 5 illustrates an example of an integrated circuit card (ICC) for use in event ticket authorization, in accordance with yet another embodiment.

FIG. 6A illustrates a method for providing to a customer an ICC storing data indicative of a valid event ticket, in accordance with yet another embodiment.

FIG. 6B illustrates a method in accordance with FIG. 6A for validating an event ticket using the ICC.

FIG. 7A illustrates a method for providing a valid event ticket to a customer using an ICC already in the possession of the customer, in accordance with another embodiment.

FIG. 7B illustrates a method in accordance with FIG. 7A for validating an event ticket using the ICC.

FIG. 8A illustrates a method for providing a valid event ticket to a customer using a personalized seed value for an ICC already in the possession of the customer, in accordance with another embodiment.

FIG. 8B illustrates a method in accordance with FIG. 8A for validating an event ticket using the personalized seed value of the ICC.

### DETAILED DESCRIPTION

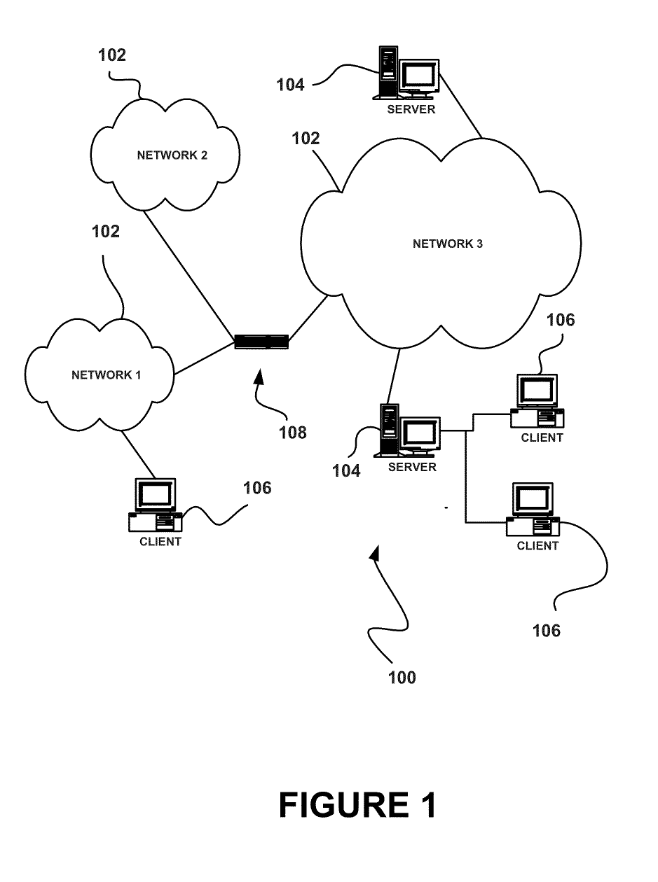

FIG. 1 illustrates a network architecture 100, in accordance with one embodiment. As shown, a plurality of networks 102 is provided. In the context of the present network architecture 100, the networks 102 may each take any form including, but not limited to a local area network (LAN), a wireless network, a wide area network (WAN) such as the Internet, peer-to-peer network, etc.

Coupled to the networks 102 are servers 104 which are capable of communicating over the networks 102. Also coupled to the networks 102 and the servers 104 is a plurality of clients 106. Such servers 104 and/or clients 106 may each include a desktop computer, lap-top computer, hand-held computer, mobile phone, personal digital assistant (PDA), peripheral (e.g. printer, etc.), any component of a computer, and/or any other type of logic. In order to facilitate communication among the networks 102, at least one gateway 108 is optionally coupled therebetween.

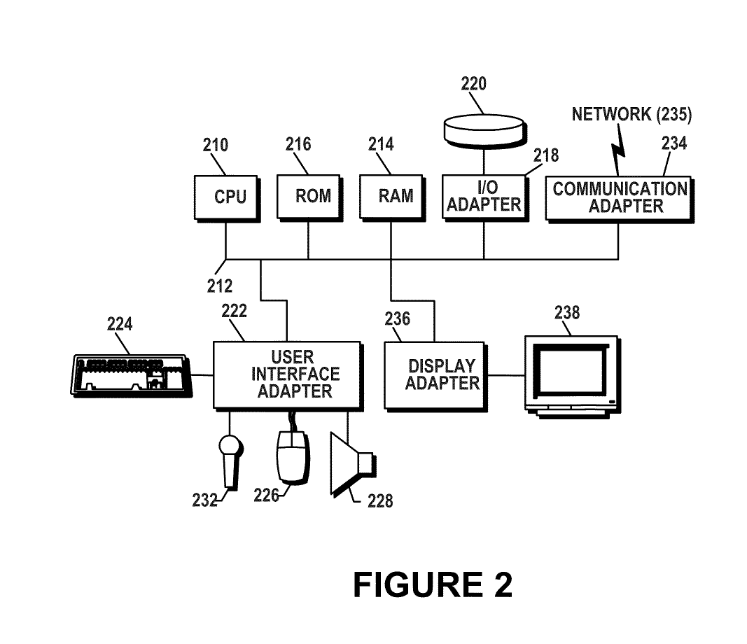

FIG. 2 shows a representative hardware environment that may be associated with the servers 104 and/or clients 106 of FIG. 1, in accordance with one embodiment. Such figure illustrates a typical hardware configuration of a workstation in accordance with one embodiment having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network 235 (e.g., a data processing network) and a display adapter 236 for connecting the bus 212 to a display device 238.

The workstation may have resident thereon any desired operating system. It will be appreciated that an embodiment may also be implemented on platforms and operating systems other than those mentioned. One embodiment may be written using JAVA, C, and/or C++ language, or other programming languages, along with an object oriented programming methodology. Object oriented programming (OOP) has become increasingly used to develop complex applications.

Of course, the various embodiments set forth herein may be implemented utilizing hardware, software, or any desired combination thereof. For that matter, any type of logic may be utilized which is capable of implementing the various functionality set forth herein.

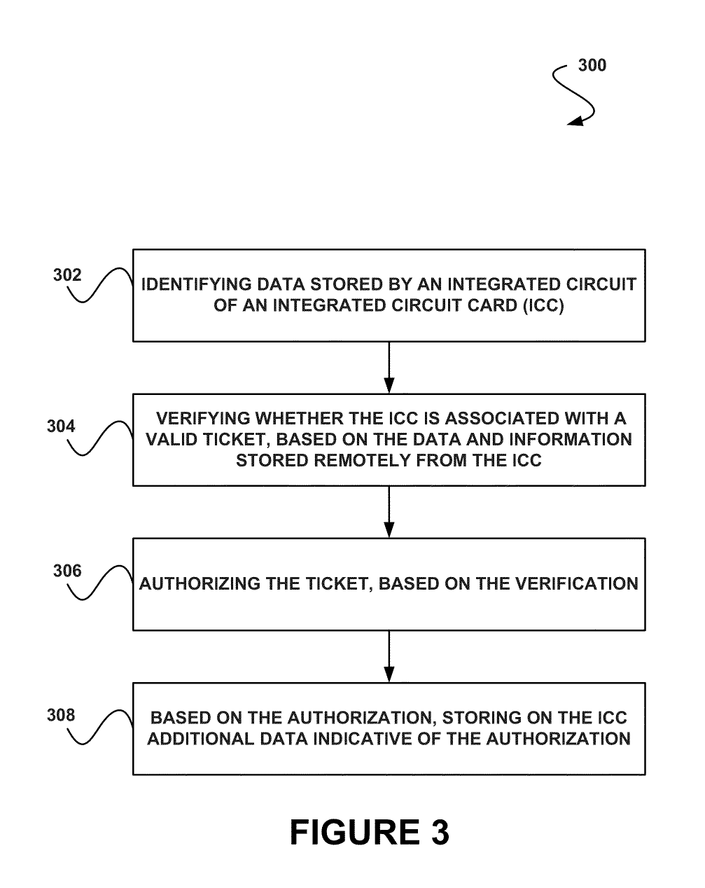

FIG. 3 illustrates a method 300 for ticket authorization, in accordance with one embodiment. As an option, the method 300 may be carried out in the context of the architecture and environment of FIGS. 1 and/or 2. Of course, however, the method 300 may be carried out in any desired environment.

As shown in operation 302, data stored by an integrated circuit of an integrated circuit card (ICC) is identified. In the context of the present description, the ICC is any hardware device having an integrated circuit capable of storing data. In one embodiment, the integrated circuit card may be a processor card having a secure execution environment and secure data storage capabilities in the integrated circuit. For example, the processor card may provide the secure execution environment and secure data storage for custom applications (e.g. implemented in Java programming language on the ICC) via cryptographic facilities of the ICC.

In another embodiment, the integrated circuit card may be a data card having only the secure data storage capabilities in the integrated circuit. It should be noted that in any case the ICC has storage capabilities for storing data in a manner that allows for retrieval thereof by an external device. In various embodiments, retrieval of the data from the storage of the integrated circuit of the ICC may be performed via physical contact between the ICC and the external device (e.g. using physical contacts on the ICC, etc.), or without physical contact between the ICC and the external device (e.g. ISO/IEC 14443 technology, near field communication (NFC) technologies, etc.).

Moreover, the data stored by the integrated circuit of the ICC may be any data capable of being utilized, at least in part, for verifying whether the ICC is associated with a valid ticket. Just by way of example, the data may be an identifier of the ticket (e.g. uniquely identifying a ticket to an event, a ticket for a product, a ticket for a service, etc.), an identifier of the ICC (e.g. uniquely identifying the ICC), a seed value personalized for the ICC (e.g. for use in calculating various values) or a unique value derived therefrom, etc. Various examples of such data will be described in more detail below with reference to the subsequent figures. Accordingly, the data may or may not include an explicit ticket, and in either case the ICC may be capable of being used for ticket authorization, as described in more detail below.

Accordingly, the ICC may be owned by a user (e.g. customer). The user may purchase the ICC, or be given the ICC upon a purchase of a ticket. Further, the ICC may be utilized for various purposes, including ticket authorization as described below.

Additionally, as shown in operation 304, it is verified whether the ICC is associated with a valid ticket, based on the data and information stored remotely from the ICC. Such ticket may be any digital resource, object, token, container, etc. representative of a right to attend an event, a right to ownership of a particular product, a right to receive a particular service, etc. For example, the ticket may be to an organized gathering (e.g. concert, etc.), to a venue, etc. Thus, a valid ticket may entitle a user of the ICC to attend the associated event or obtain a particular product, whereas an invalid ticket may not necessarily entitle the user of the ICC to attend the associated event or obtain the particular product.

As noted above, the data stored by the integrated circuit of the ICC may be retrievable by an external device. Such external device may be any terminal device (e.g. computer, etc.) capable of retrieving the data from the ICC using contact or contactless communication with the ICC. Thus, the verification of whether the ICC is associated with a valid ticket may be performed by the external device upon retrieval of the data from the ICC.

The verification of whether the ICC is associated with a valid ticket is further based on information stored remotely from the ICC. In one embodiment, the information may be stored by the external device. In another embodiment, the information may be stored by a central server or other central repository, and may be retrieved for example by the external device for performing the verification.

Such information may be dependent on the type of data stored by the ICC that is used for the verification. For example, where the data stored by the ICC is an identifier of the ticket, the information stored remotely from the ICC may be identifiers of valid tickets. In such embodiment, the verification may be performed by comparing the identifier of the ticket included in the data stored by the ICC with the identifiers of valid tickets included in the information stored remotely from the ICC.

As another example, where the data stored by the ICC is an identifier of the ICC, the information stored remotely from the ICC may be identifiers of ICCs each associated with a valid ticket. In such embodiment, the verification may be performed by comparing the identifier of the ICC included in the data stored by the ICC with the identifiers of ICCs each associated with a valid ticket included in the information stored remotely from the ICC.

As yet another example, where the data stored by the ICC is a seed value personalized for the ICC or a unique value derived therefrom, the information stored remotely from the ICC may seed values for ICCs each associated with a valid ticket or values derived from seed values for ICCs each associated with a valid ticket. In such embodiment, the verification may be performed by comparing the seed value/derived value included in the data stored by the ICC with the seed values/derived values for ICCs each associated with a valid ticket included in the information stored remotely from the ICC.

To this end, the verification of whether the ICC is associated with a valid ticket may be performed based on any of the aforementioned comparisons. For example, if the comparison results in a match, it may be verified that the ICC is associated with a valid ticket. However, if the comparison does not result in a match, it may be verified that the ICC is not associated with a valid ticket. Of course, it should be noted that the aforementioned verification of whether the ICC is associated with a valid ticket may be performed on any manner that is based on the data stored by the ICC and the information stored remotely from the ICC.

Further, as shown in operation 306, the ticket is authorized, based on the verification. In one embodiment, if it is verified that the ICC is associated with a valid event ticket, the valid event ticket may be authorized (e.g. for entry to the associated event). In particular, such authorization may include a notification e.g. presented via the external device) that the user of the ICC is to be allowed entry to the associated event, is allowed to obtain a particular product, etc.

In another embodiment, if it is verified that the ICC is not associated with a valid ticket, the invalid ticket may not be authorized (e.g. for entry to the associated event). For example, preventing such authorization when the ticket is invalid may include presenting a notification that the user of the ICC is not to be allowed entry to the associated event, is not allowed to obtain a particular product, etc.

Still yet, as shown in operation 308, based on the authorization, additional data indicative of the authorization is stored on the ICC. In one embodiment, the additional data indicative of the authorization may be stored on the ICC when the ticket is authorized. Further to such embodiment, the additional data indicative of the authorization may not necessarily be stored on the ICC when the ticket is not authorized.

Optionally, the additional data stored on the ICC may be a mark, flag, or any other indicator that the ticket is used (e.g. has been used to grant the user entry to the event). Of course, however, the additional data may be any code or other data indicating the authorization of the ticket. In this way, the additional data may optionally be used for preventing subsequent use of the ticket (e.g. for another entry to the associated event, etc.).

More illustrative information will now be set forth regarding various optional architectures and features with which the foregoing technique may or may not be implemented, per the desires of the user. It should be strongly noted that the following information is set forth for illustrative purposes and should not be construed as limiting in any manner. Any of the following features may be optionally incorporated with or without the exclusion of other features described. For example, while the below embodiments are described with reference to events, it should be noted that such embodiments may equally apply to tickets used to represent a right to a product, service, etc.

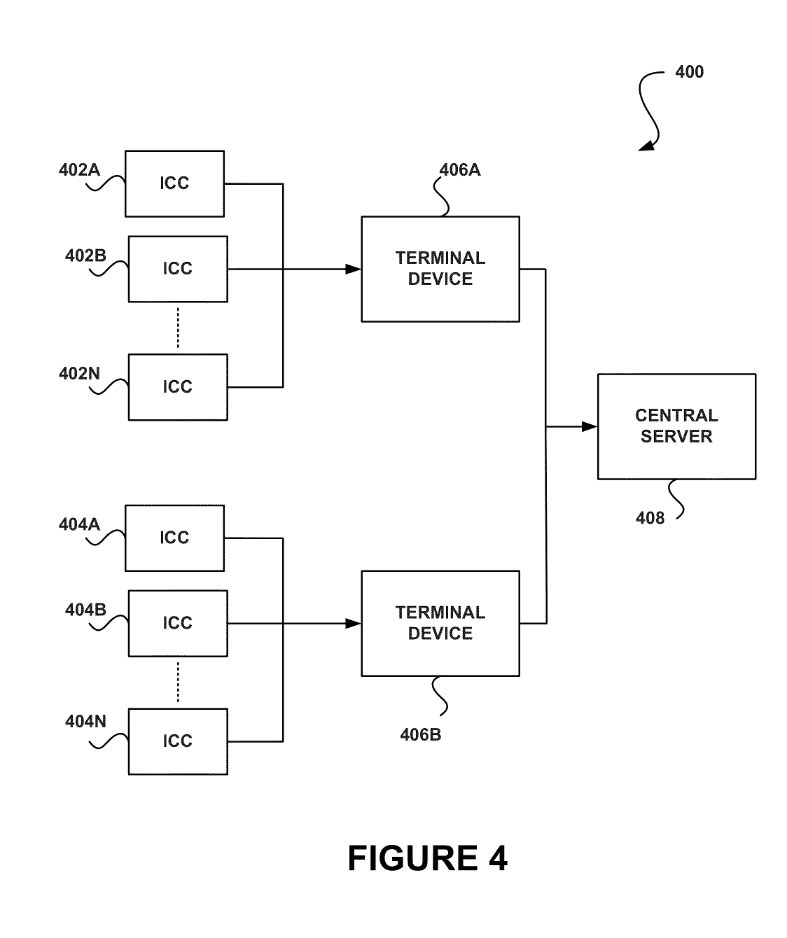

FIG. 4 illustrates a system 400 for event ticket authorization, in accordance with another embodiment. As an option, the system 400 may be implemented in the context of the architecture and environment of FIGS. 1-3. Of course, however, the system 400 may be implemented in any desired environment. Again, it should be noted that the aforementioned definitions may apply during the present description.

As shown, the system 400 includes a first set of ICCs 402A-N each in communication with a first terminal device 406A. The system 400 also includes a second set of ICCs 404A-N each in communication with a second terminal device 406B. It should be noted that the present system should not be limited to the number of ICCs and/or terminal devices shown, but that each set of ICCs may include any number of ICCs (i.e. one or more), and that any number of terminal devices may be included.

In the present embodiment, the system 400 is implemented for a particular event (e.g. concert, etc.) for which event tickets may be sold or in any way distributed to customers, whereby the terminal devices are utilized at or near an entrance to the event, for use in authorizing entry to the event. In one embodiment, the event tickets may be distributed to the customers using the ICCs of the customers. Various embodiments for distributing such event tickets will be described in more detail with reference to the subsequent figures.

To obtain entry to the event, ICCs communicate with the terminal devices, whether by communication involving physical contact between the ICCs and terminal devices, or by contactless communication. Such communication may involve algorithms for mutual authentication between the ICCs and the terminal devices, for example based on symmetric or asymmetric cryptographic functions, public key infrastructure (PKI), elliptic cryptography, etc.

As shown, the first set of ICCs 402A-N communicate with the first terminal device 406A in a manner that allows the first terminal device 406A to retrieve data stored by each of the ICCs in the first set of ICCs 402A-N. Similarly, the second set of ICCs 404A-N communicate with the second terminal device 406B in a manner that allows the second terminal device 406B to retrieve data stored by each of the ICCs in the second set of ICCs 404A-N.

The terminal devices also communicate with a central server 408 (e.g. via a network). The central server 408 may be any central repository storing information capable of being used for validating the event tickets distributed to the customers using the ICCs of the customers. Of course, while the central server 408 is shown as a component of the system 400, in another optional embodiment each of the terminal devices may store a copy of the information otherwise stored by the central server 408 (e.g. such that the terminal devices may be “offline” or otherwise not necessarily connected to a network).

As shown, the first terminal device 406A communicates with the central server 408 in a manner that allows the first terminal device 406A to retrieve information stored by the central server 408. The first terminal device 406A may query the central server 408 for the information, in one embodiment. For example, for each of the ICCs in the first set of ICCs 402A-N, the first terminal device 406A may query the central server 408 for information matching the data retrieved from such ICC. In any case, if the data retrieved from the ICC matches information stored by the central server 408 (e.g. the query results in a match being returned), the ICC may be verified as being associated with a valid event ticket. The event ticket associated with the ICC may then be authorized for entry by the user to the event. If, however, the data retrieved from the ICC does not match information stored by the central server 408 (e.g. the query does not result in a match being returned), the ICC may be verified as being associated with an invalid event ticket. The invalid event ticket associated with the ICC may then prohibit entry by the user to the event.

Similarly, the second terminal device 406B communicates with the central server 408 in a manner that allows the second terminal device 406B to retrieve information stored by the central server 408. The second terminal device 406B may query the central server 408 for the information, in one embodiment. For example, for each of the ICCs in the second set of ICCs 404A-N, the second terminal device 406B may query the central server 408 for information matching the data retrieved from such ICC. In any case, if the data retrieved from the ICC matches information stored by the central server 408 (e.g. the query results in a match being returned), the ICC may be verified as being associated with a valid event ticket. The event ticket associated with the ICC may then he authorized for entry by the user to the event. If, however, the data retrieved from the ICC does not match information stored by the central server 408 (e.g. the query does not result in a match being returned), the ICC may be verified as being associated with an invalid event ticket. The invalid event ticket associated with the ICC may then prohibit entry by the user to the event.

Further, additional data may optionally be stored on each ICC by the respective terminal device. For example, where the first terminal device 406A authorizes the event ticket associated with an ICC in the first set of ICCs 402A-N for entry by the user to the event, the first terminal device 406A may store additional data on such ICC indicating the authorization. As another example, where the second terminal device 406B authorizes the event ticket associated with an ICC in the second set of ICCs 404A-N for entry by the user to the event, the second terminal device 406B may store additional data on such ICC indicating the authorization.

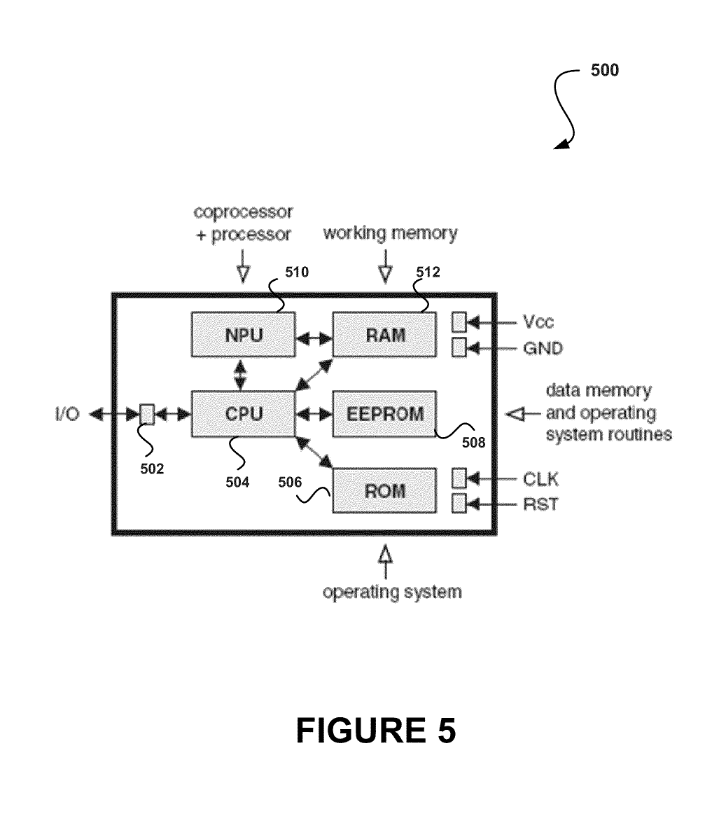

FIG. 5 illustrates an example of an ICC 500 for use in event ticket authorization, in accordance with yet another embodiment. As an option, the ICC 500 may be implemented in the context of the architecture and environment of FIGS. 1-4. For example, the ICC 500 may be a processor card as described above with reference to FIG. 3. Of course, however, the ICC 500 may be implemented in any desired environment. Again, it should be noted that the aforementioned definitions may apply during the present description.

As shown, the ICC 500 includes an input/output interface 502 for receiving/sending data (e.g. for storage thereof). The input/output interface 502 may include physical contacts or may be contactless for receiving/sending data. Received data may be stored in memory (e.g. RAM 512, Electrically Erasable Programmable Memory (EEPROM) 508, etc.) of the ICC 500. Such data may be an identifier of an event ticket, information describing a user of the ICC 500, information describing an event associated with the event ticket, etc. The ICC 500 also includes ROM 506, which may for example be preprogrammed with an identifier of the ICC 500 during the manufacturing of the ICC 500.

The ICC 500 also includes a central processing unit (CPU) 504 that utilizes EEPROM 508 for performing various operations (e.g. executing applications, operating system routines, etc.). Further, the ICC 500 includes a numeric processing unit (NPU) 510 for performing numerical calculations, particularly those dealing with cryptography.

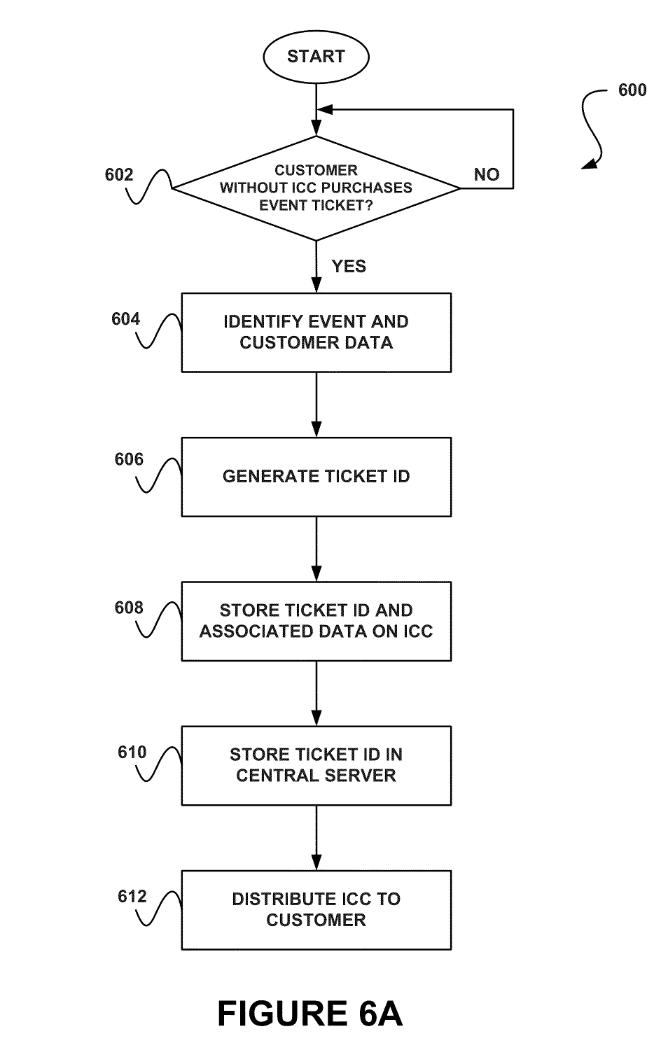

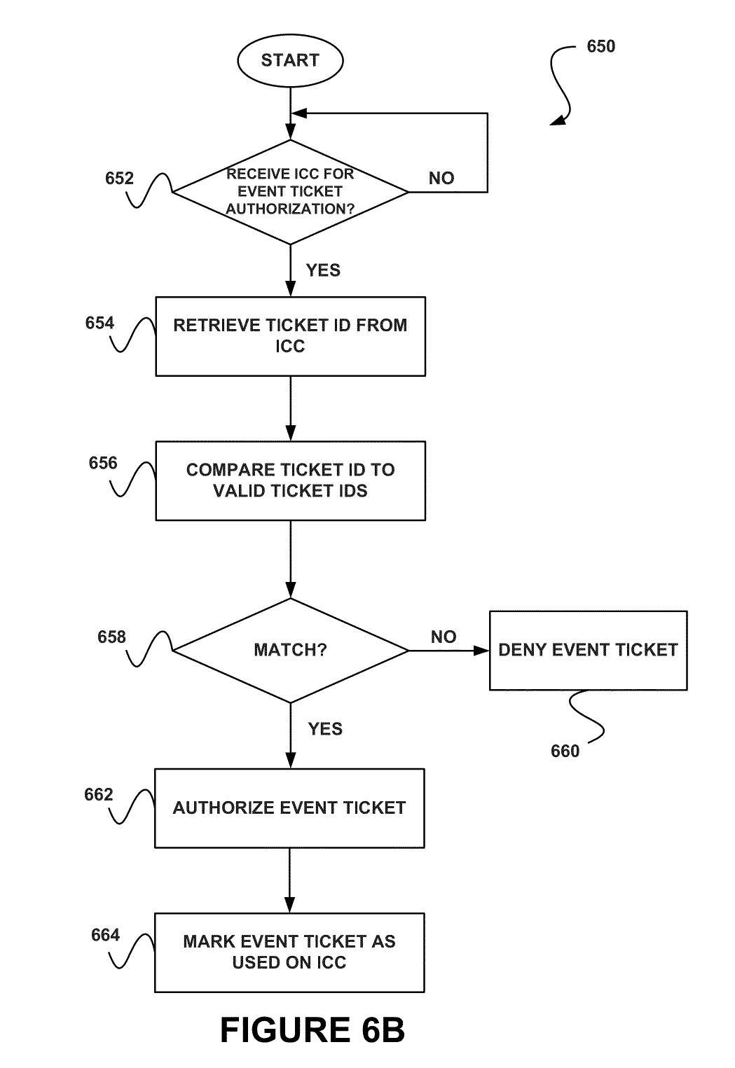

FIG. 6A illustrates a method 600 for providing to a customer an ICC storing data indicative of a valid event ticket, in accordance with yet another embodiment. As an option, the method 600 may be carried out in the context of the architecture and environment of FIGS. 1-5. For example, the method 600 may be carried out using a computer terminal at a point-of-sale. Of course, however, the method 600 may be carried out in any desired environment. It should also be noted that the aforementioned definitions may apply during the present description.

As shown in decision 602, it is determined whether a customer without an ICC purchases an event ticket. For example, the customer may purchase the event ticket from any retailer of tickets to an event. Optionally, the method 600 may be implemented where the customer does not necessarily purchase the event ticket, but instead the event ticket is distributed to the customer free of charge.

If it is determined that a customer without an ICC does not purchase an event ticket, the method 600 continues to wait for a determination that a customer without an ICC has purchased an event ticket. Once it is determined that a customer without an ICC has purchased an event ticket, the method 600 identifies the event and customer data. Note operation 604. The event data may be any data associated with the event, such as an identifier of the event, time of the event, name of the event, etc. Further, the customer data may be any data associated with the customer, such as a name of the customer, etc. Optionally, the event and customer data may be entered by a salesperson from which the event ticket is purchased, by a system from which the event ticket is purchased, from input entered by the customer, etc.

Additionally, a ticket identifier (ID) is generated, as shown in operation 606. The ticket ID may be any unique identifier (e.g. number, string, etc.) that uniquely identifies the event ticket purchased by the customer. The ticket ID and associated data are then stored on an ICC, as shown in operation 608. For example, the ticket ID may be stored by an integrated circuit of the ICC. In the context of the present embodiment, the associated data may be the customer and event data identified in operation 604, a unique ID of the ICC (ICC ID), etc. Further, the ticket ID is stored in a central server (operation 610) and the ICC is distributed to the customer (operation 612). As an option, the ticket ID may be stored in the central server in association with the ICC ID, customer and event data, etc.

FIG. 6B illustrates a method 650 in accordance with FIG. 6A for validating an event ticket using the ICC. As an option, the method 650 may be implemented in the context of the architecture and environment of FIGS. 1-6A. For example, the method 650 may be carried out using the terminal device of FIG. 4. Of course, however, the method 650 may be implemented in any desired environment. Again, it should be noted that the aforementioned definitions may apply during the present description.

In decision 652, it is determined whether an ICC is received for event ticket authorization. The decision 652 may be based on whether the ICC is in a position such that data is able to be read therefrom. For example, it may be determined that an ICC is received for event ticket authorization when an ICC is physically connected to or otherwise in close enough proximity to retrieve data therefrom. If it is determined in decision 652 that an ICC is not received for event ticket authorization, the method 650 continues to wait for receipt of an ICC.

Once it is determined that an ICC is received for event ticket authorization, a ticket ID is retrieved from the ICC. Note operation 654. Additionally, the ticket ID is compared to valid ticket IDs, as shown in operation 656. For example, the valid ticket IDs may be included in information stored remotely from the ICC (e.g. at the central server of FIG. 4), and may be a plurality of identifiers of a plurality of event tickets stored remotely from the ICC in response to users purchasing the plurality of the event tickets.

Further, it is determined, based on the comparison, whether there is a match. Note decision 658. If it is determined in decision 658 that there is no match, the event ticket is denied (operation 660). For example, a notification that the ICC is not associated with a valid event ticket may be presented such that the user of the ICC may be denied entrance to the event.

If is it determined in decision 658 that there is a match, the event ticket is authorized. Note operation 662. For example, a notification that the ICC is associated with a valid event ticket may be presented such that the user of the ICC may be allowed entrance to the event. Further, as shown in operation 664, the event ticket is marked on the ICC as used.

To this end, it may be verified via 656-658 whether the ICC is associated with a valid event ticket, base on the ticket ID stored on the ICC and the valid ticket IDs stored remotely from the ICC, by: comparing ticket ID stored by the ICC with the ticket IDs stored remotely from the ICC, verifying that the ICC is not associated with a valid event ticket when it is determined from the comparison that the ticket ID stored by the ICC does not match any of the ticket IDs stored remotely from the ICC, and verifying that the ICC is associated with a valid event ticket when it is determined from the comparison that the ticket ID stored by the ICC matches one of the ticket IDs stored remotely from the ICC.

Exemplary Use Case of FIGS. 6A-6B

If a customer does not possess an ICC, he must purchase a first event ticket from a box office, a “brick and mortar” merchant. The clerk at the box office accepts the payment and issues the new ICC to the customer. The ticket issuing process includes personalization of the ICC for the customer and storing some customer data on the ICC and in a central server. Optionally (e.g. in the central server), an ID of the ICC may be associated with an identifier of the customer, and an array of data containers stored on the ICC or generated by an application executed on the ICC may also be associated with the identifier of the customer.

The ticket issuing process further includes storing a ticket ID on the ICC that may be associated with some information about the event (e.g. an event ID, etc.). The ticket ID is securely stored on the ICC. During the ticket sales process a central server application “enables” the ticket by marking its ticket ID as a valid and authentic ticket in its database. Some additional properties of the ticket may be stored in the central server database, for example: price paid for the ticket, number of persons, date and timestamp of when the ticket was sold, etc.

When the customer desires to be granted access to an event for which he purchased the event ticket, he presents the ICC to a ticket collector at the entry to the venue. The ticket collector equipped with a terminal device reads the data from the ICC, and validates it by comparing the ticket ID to the valid ticket IDs stored by the central server. In case the valid ticket is encoded on the ICC, access to the venue is granted for the customer.

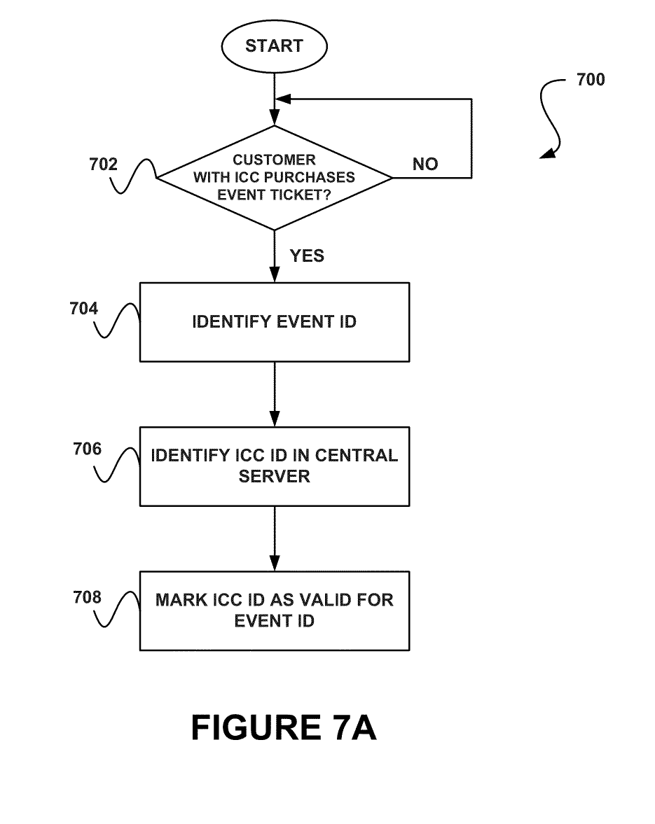

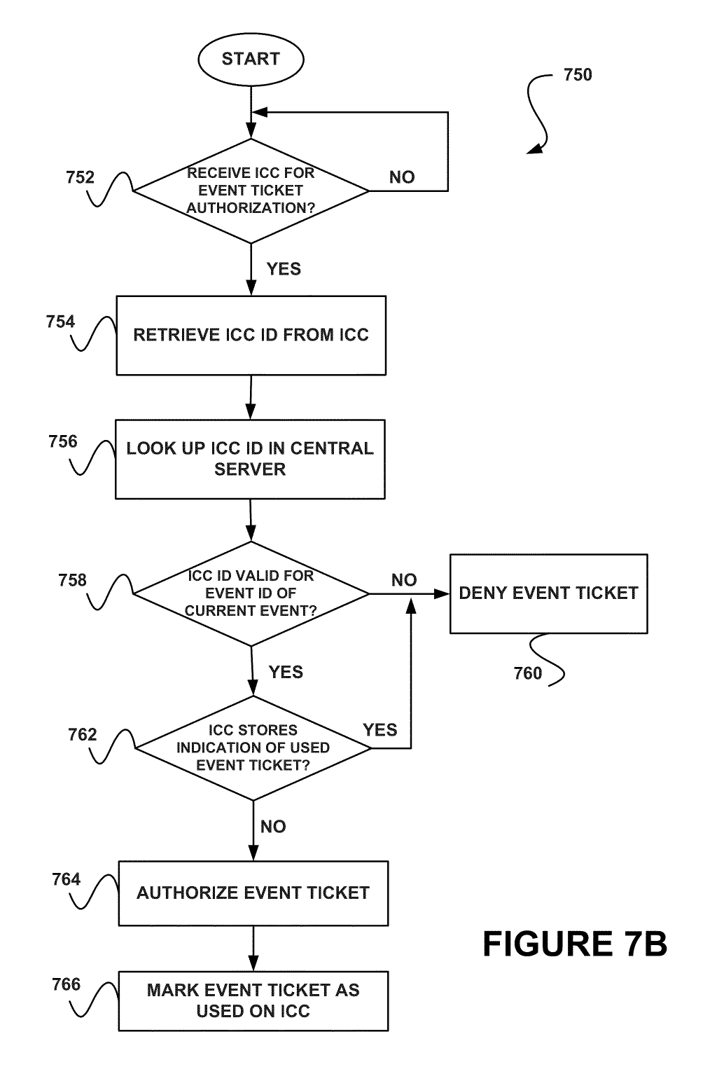

When the customer desires to purchase another event ticket, he can use the same ICC and present it to the box office for encoding the new event ticket, for example as described below with reference to FIGS. 7A-B. Accordingly, the customer can keep the ICC and purchase additional event tickets remotely, using Internet commerce or another remote payment mechanism. The new event ticket may not be directly encoded on the existing ICC, but the existing ICC may be used to securely validate the newly purchased event ticket at the point of entry to the event, either by using a pre-stored data container, associated with the ticket at the time of sale, or by executing an authentication application stored on the ICC.

FIG. 7A illustrates a method 700 for providing a valid event ticket to a customer using an ICC already in the possession of the customer, in accordance with another embodiment As an option, the method 700 may be carried out in the context of the architecture and environment of FIGS. 1-6B. For example, the method 700 may be carried out using a computer terminal at a point-of-sale. Of course, however, the method 700 may be carried out in any desired environment. It should also be noted that the aforementioned definitions may apply during the present description.

As shown in decision 702, it is determined whether a customer with an ICC purchases an event ticket. For example, the customer may purchase the event ticket from any retailer of tickets to an event. Optionally, the method 700 may be implemented where the customer does not necessarily purchase the event ticket, but instead the event ticket is distributed to the customer free of charge.

If it is determined that a customer with an ICC does not purchase an event ticket, the method 700 continues to wait for a determination that a customer with an ICC has purchased an event ticket. Once it is determined that a customer with an ICC has purchased an event ticket, the method 700 identifies an event ID (operation 704). The event ID may be any unique identifier of the event to which the customer has purchases a ticket.

Further, as shown in operation 706, an ICC ID is identified in a central server, the context of the present embodiment, the ICC ID may be any unique identifier of an ICC of the customer. As an option, the ID of the ICC of the customer may be stored in the central server upon the customer purchasing an event ticket without already having the ICC (e.g. as described above with respect to FIG. 6A). Further customer data may be stored in the central server in association with the ICC ID. In this way, the ICC ID may be identified from the central server in operation 706 by looking up the ICC ID using any identifying information of the customer.

Once the ICC ID is identified, the ICC ID is marked in the central server as valid for the event ID. Note operation 708. Just by way of example, the ICC ID stored in the central server may be marked as valid for the event by storing the event ID in association with the ICC ID. In this way, the central server may include a record that the customer has purchased, and thus owns, a valid ticket to the event.

FIG. 7B illustrates a method 750 in accordance with FIG. 7A for validating an event ticket using the ICC. As an option, the method 750 may be carried out in the context of the architecture and environment of FIGS. 1-6B. For example, the method 750 may be carried out using the terminal device of FIG. 4. Of course, however, the method 750 may be implemented in any desired environment. Yet again, it should be noted that the aforementioned definitions may apply during the present description.

As shown in decision 752, it is determined whether an ICC is received for event ticket authorization. The decision 752 may be based on whether the ICC is in a position such that data is able to be read therefrom. For example, it may be determined that an ICC is received for event ticket authorization when an ICC is physically connected to or otherwise in close enough proximity to retrieve data therefrom. If it is determined in decision 752 that an ICC is not received for event ticket authorization, the method 750 continues to wait for receipt of an ICC.

Once it is determined that an ICC is received for event ticket authorization, the method 750 continues to operation 754 where an ICC ID is retrieved from the ICC. For example, the ICC may store a unique ID thereof. Such ICC ID may be configured upon a manufacturing of the ICC. As another option, the ICC ID may be configured upon a distribution of the ICC to a customer, such as by a sales person during purchase of a first event ticket to be stored on the ICC (as described in FIG. 6A). Further, upon distribution of the ICC to a customer, the ICC ID may be stored in a central server in association with data describing the customer (e.g. customer ID, etc.).

Additionally, the ICC ID is looked up in the central server, as shown in operation 756. Accordingly, the ICC ID retrieved from the ICC that has been received for event ticket authorization may be looked up in the central server. In the present embodiment, ICC IDs in the central server may be marked as valid for a particular event ID when a user of the associated ICC having the ICC ID has purchased a ticket to the event.

In decision 758 it is determined whether the ICC ID is valid for the event ID of the current event. Such current event is the event to which the user of the ICC has indicated a desire to enter by presenting the ICC for event ticket authorization. Such determination may be made based on a result of the look up in performed in operation 756. For example, it may be determined whether the ICC ID retrieved from the ICC is stored in the central server in association with a mark indicating that the ICC ID is valid for the event ID of the current event.

If the ICC ID is stored in the central server in association with the mark/event ID, it may be determined that the ICC ID is valid for the event ID of the current event. If the ICC ID is not stored in the central server in association with the mark/event ID, it may be determined that the ICC ID is invalid for the event ID of the current event. If it is determined that the ICC ID is invalid for the event ID of the current event, the event ticket is denied. Note operation 760. For example, a notification that the ICC is not associated with a valid event ticket may be presented such that the user of the ICC may be denied entrance to the event.

If is it determined in decision 758 that the ICC ID is valid for the event ID of the current event, it is further determined in decision 762 whether the ICC stores an indication that the event ticket has been used. If it is determined that the ICC stores an indication that the event ticket has been used, the event ticket is denied (operation 760). However, if it is determined that the ICC does not store an indication that the event ticket has been used, the event ticket is authorized, as shown in operation 764. For example, a notification that the ICC is associated with a valid event ticket may be presented such that the user of the ICC may be allowed entrance to the event. Further, as shown in operation 766, the event ticket is marked on the ICC as used.

To this end, it may be verified via 758 and 762 whether the ICC is associated with a valid event ticket, based on the ICC ID stored on the ICC and a plurality of identifiers of a plurality of ICCs stored remotely from the ICC (e.g. in the central server that are each marked as valid for an event ID associated with the event, by in particular: looking up, in the central server, the identifier of the ICC included in the data stored by the ICC; determining, based on the look-up, whether the ICC ID is marked, in the central server, as valid for the event ID associated with the event; and determining whether the ICC further stores an indication that the event ticket is used. Further, it may be (1) verified that the ICC is not associated with the valid event ticket when it is determined, based on the look-up, that the ICC ID stored by the ICC is not marked, in the central server, as valid for the event ID associated with the event; (2) verified that the ICC is not associated with the valid event ticket when it is determined, based on the look-up, that the ICC ID stored by the ICC is marked, in the central server, as valid for the event ID associated with the event and when it is determined that the ICC further includes the indication that the event ticket is used; and (3) verified that the ICC is associated with the valid event ticket when it is determined, based on the look-up, that the ICC ID stored by the ICC is marked, in the central server, as valid for the event ID associated with the event and when it is determined that the ICC does not include the indication that the event ticket is used.

Exemplary Use Case of FIGS. 7A-7B

In an embodiment where the customer already possesses an ICC, the ticket sales process includes (1) identify event and customer ID; retrieve the ICC identifier from the server database; (2) Process the payment transaction; (3) Mark the ICC ID as a “valid” for the specific event ID.

To validate the event ticket, a terminal device may be preloaded with all valid ICC IDs valid for the event, or may be in communication with a central server storing all valid ICC IDs valid for the event. The ICC is presented to the terminal device and the following sequence of steps takes place: (1) The terminal device reads the ICC ID; (2) If the ICC ID is marked as valid for the current event ID and the ICC does not contain any data that indicates that this event ticket has already been used for accessing this event, the terminal (1) Grants access to the event to the ICC user; and (b) Securely stores on the ICC some data that identifies that the current event ticket was used to get access to this specific event.

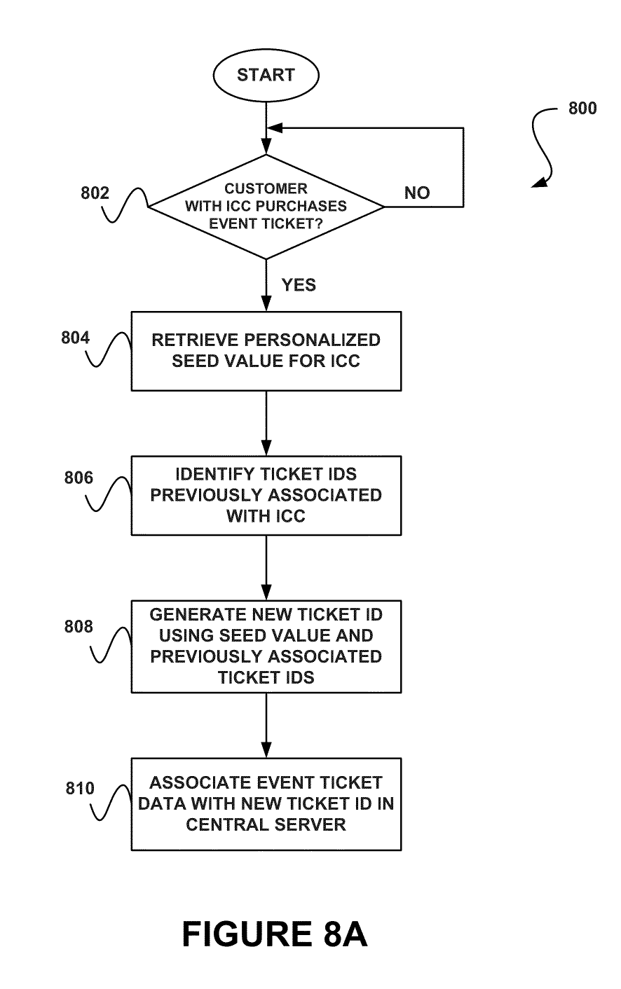

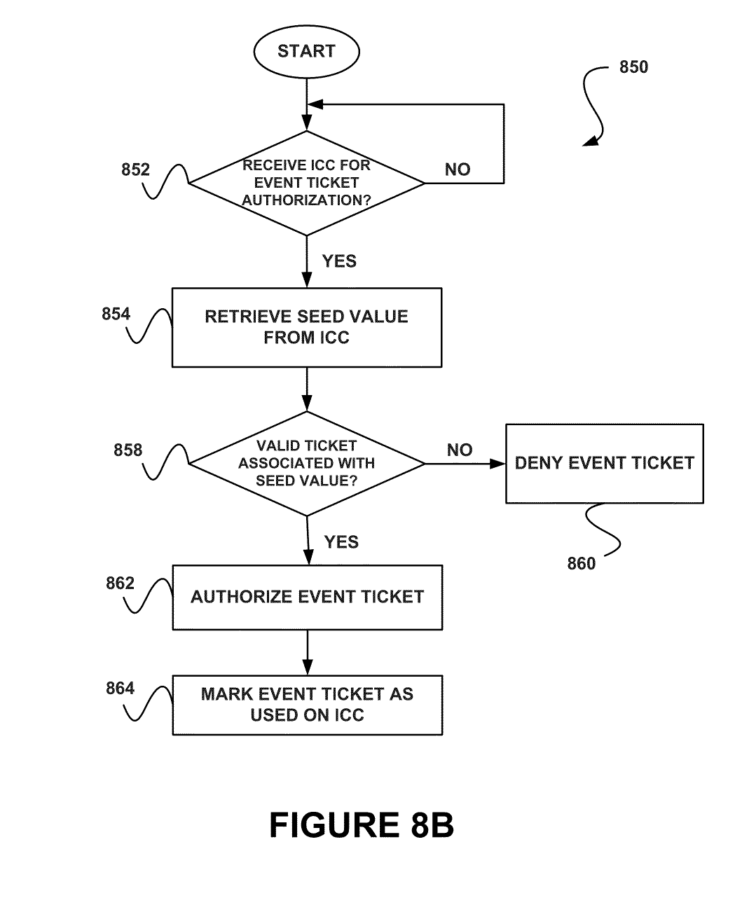

FIG. 8A illustrates a method 800 for providing a valid event ticket to a customer using a personalized seed value for an ICC already in the possession of the customer, in accordance with another embodiment. As an option, the method 800 may be carried out in the context of the architecture and environment of FIGS. 1-7B. For example, the method 800 may be carried out using a computer terminal at a point-of-sale. Of course, however, the method 800 may be carried out in any desired environment. Again, it should be noted that the aforementioned definitions may apply during the present description.

As shown in decision 802, it is determined whether a customer with an ICC purchases an event ticket. For example, the customer may purchase the event ticket from any retailer of tickets to an event. Optionally, the method 800 may be implemented where the customer does not necessarily purchase the event ticket, but instead the event ticket is distributed to the customer free of charge.

If it is determined that a customer with an ICC does not purchase an event ticket, the method 800 continues to wait for a determination that a customer with an ICC has purchased an event ticket. Once it is determined that a customer with an ICC has purchased an event ticket, the method 800 retrieves a personalized seed value for the ICC. Note operation 804. Accordingly, an integrated circuit of the ICC may store a seed value personalized for the ICC.

For example, a ticket application located on the ICC may implement a cryptographically secure function that calculates a sequence of numbers with the following properties: (1) Each subsequent number is calculated as a function of a previous number and some other optional values, for example “salt” value; (2) The sequence does not include repeating numbers; and (3) If two different ICCs are personalized with different initial values, sequences generated by ticket applications on two ICCs never contain the same numbers. Each subsequent number in the sequence represents the next available ticket ID for the current ICC.

The ticket application on the ICC may also implement the following functions and data elements: (1) Data element “counter”—indicates the greatest ordinal number of the ticket ID generated by the cryptographically secure function on the ICC; and (2) Function that associates one or more structured data elements with the “ticket ID”; (3) Function that retrieve data elements previously associated with the ticket ID; (4) Function that returns the seed value with which the current ICC is personalized; and (5) Function that looks up the ticket ID by the data elements associated with it (“search”).

Further, a central server may store all seed values with which all ICCs are personalized. Thus, the central server may store the seed value in association with an ICC ID and data describing a customer owning the ICC. Accordingly, during the process of selling the ticket, the seed value for the ICC may be retrieved from the central server, for example, by querying the central server using the customer data.

Further, as shown in operation 806, ticket IDs previously associated with the ICC are identified. For example, such ticket IDs may be stored in the central server in association with the seed value or, for example, an ID of the ICC. A new ticket ID is then generated using the seed value and the previously associated ticket IDs. Note operation 808. Moreover, event ticket data is associated with the new ticket ID in the central server.

FIG. 8B illustrates a method 850 in accordance with FIG. 8A for validating an event ticket using the personalized seed value of the ICC. As an option, the method 850 may be carried out in the context of the architecture and environment of FIGS. 1-8A. For example, the method 850 may be carried out using the terminal device of FIG. 4. Of course, however, the method 850 may be carried out in any desired environment. It should also be noted that the aforementioned definitions may apply during the present description.

As shown in decision 852, it is determined whether an ICC is received for event ticket authorization. The decision 852 may be based on whether the ICC is in a position such that data is able to be read therefrom. For example, it may be determined that an ICC is received for event ticket authorization when an ICC is physically connected to or otherwise in close enough proximity to retrieve data therefrom. If it is determined in decision 852 that an ICC is not received for event ticket authorization, the method 850 continues to wait for receipt of an ICC.

Once it is determined that an ICC is received for event ticket authorization, the method 850 continues to operation 854 where a seed value is retrieved from the ICC. For example, the ICC may store a unique seed value. Such seed value may be configured upon a manufacturing of the ICC. As another option, the seed value may be configured upon a distribution of the ICC to a customer, such as by a sales person during purchase of a first event ticket to be stored on the ICC (as described in FIG. 6A). Further, upon distribution of the ICC to a customer, the seed value may be stored in a central server in association with data describing the customer (e.g. customer ID, etc.) and/or the ICC ID.

Additionally, it is determined in decision 858 whether a valid event ticket is associated with the seed value. For example, the seed value may be used to determine whether a valid ticket is associated with the ICC. Such seed value may be looked up in a central server for making the determination, or a ticket ID may be generated from the seed value retrieved from the ICC and then such ticket ID may be looked up in the central server for making the determination.

If it is determined in decision 858 that a valid event ticket is not associated with the seed value, the event ticket is denied. Note operation 860. For example, a notification that the ICC is not associated with a valid event ticket may be presented such that the user of the ICC may be denied entrance to the event.

If is it determined in decision 858 that a valid event ticket is associated with the seed value, the event ticket is authorized. Note operation 862. For example, a notification that the ICC is associated with a valid event ticket may be presented such that the user of the ICC may be allowed entrance to the event. Further, as shown in operation 864, the event ticket is marked on the ICC as used. For example, the event ticket may be marked as used by associating a set of data elements, such as the timestamp of redemption (use) and the event ID with the ticket ID, and store the same on the ICC.

To this end, it may be verified via 858 whether the ICC is associated with a valid event ticket, base on a seed value stored on the ICC and a plurality of identifiers of a plurality of event tickets stored in the central server in response to users purchasing the plurality of the event tickets (e.g. as generated using seed values personalized for ICCs of the respective users). In particular, such verification may include: determining whether one of the plurality of identifiers of the plurality of event tickets stored in the central server is associated with the seed value personalized for the ICC, verifying that the ICC is associated with the valid event ticket when it is determined that one of the plurality of identifiers of the plurality of event tickets store in the central server is associated with the seed value personalized for the ICC, and verifying that the ICC is not associated with the valid event ticket when it is determined that the seed value personalized for the ICC is not associated with any of the plurality of identifiers of the plurality of event stored in the central server.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A computer program product embodied on a non-transitory computer readable medium, comprising:
computer code for identifying data stored by an integrated circuit of an integrated circuit card (ICC);
computer code for verifying whether the ICC is associated with a valid ticket, based on the data and information stored remotely from the ICC;
computer code for authorizing the ticket, based on the verification; and
computer code for, based on the authorization, storing on the ICC additional data indicative of the authorization.

2. The computer program product of claim 1, wherein the integrated circuit card is a data card having secure data storage capabilities in the integrated circuit.

3. The computer program product of claim 1, wherein the integrated circuit card is a processor card having a secure execution environment and secure data storage capabilities in the integrated circuit.

4. The computer program product of claim 1, wherein the data stored by the integrated circuit is an identifier of the ticket.

5. The computer program product of claim 4, wherein the identifier of the ticket is generated and stored in the integrated circuit of the ICC in response to a user of the ICC purchasing the ticket.

6. The computer program product of claim 5, wherein the information stored remotely from the ICC is a plurality of identifiers of a plurality of tickets stored remotely from the ICC in response to users purchasing the plurality of the tickets.

7. The computer program product of claim 6, wherein verifying whether the ICC is associated with the valid ticket, based on the data and the information stored remotely from the ICC, includes:
comparing the identifier of the ticket included in the data stored by the integrated circuit with the plurality of identifiers of the plurality of the tickets included in the information stored remotely from the ICC;
verifying that the ICC is not associated with the valid ticket when it is determined from the comparison that the identifier of the ticket included in the data stored by the integrated circuit does not match any of the identifiers of the plurality of the tickets included in the information stored remotely from the ICC; and
verifying that the ICC is associated with the valid ticket when it is determined from the comparison that the identifier of the ticket included in the data stored by the integrated circuit matches one of the identifiers of the plurality of the tickets included in the information stored remotely from the ICC.

8. The computer program product of claim 1, wherein the data stored by the integrated circuit is an identifier of the ICC.

9. The computer program product of claim 8, wherein the information stored remotely from the ICC is a plurality of identifiers of a plurality of ICCs each marked as valid for an event ID associated with an event.

10. The computer program product of claim 9, wherein verifying whether the ICC is associated with the valid event ticket, based on the data and the information stored remotely from the ICC, includes:
looking up, in the information including the plurality of identifiers of the plurality of ICCs each marked as valid for the event ID associated with the event, the identifier of the ICC included in the data stored by the integrated circuit;
determining, based on the look-up, whether the identifier of the ICC included in the data stored by the integrated circuit is marked, in the information, as valid for the event ID associated with the event; and
determining whether the data stored by the integrated circuit further includes an indication that the ticket is used.

11. The computer program product of claim 10, wherein verifying whether the ICC is associated with the valid ticket, based on the data and the information stored remotely from the ICC, further includes:
verifying that the ICC is not associated with the valid ticket when it is determined, based on the look-up, that the identifier of the ICC included in the data stored by the integrated circuit is not marked, in the information, as valid for the event ID associated with the event;
verifying that the ICC is not associated with the valid ticket when it is determined, based on the look-up, that the identifier of the ICC included in the data stored by the integrated circuit is marked, in the information, as valid for the event ID associated with the event and when it is determined that the data stored by the integrated circuit further includes the indication that the ticket is used; and
verifying that the ICC is associated with the valid ticket when it is determined, based on the look-up, that the identifier of the ICC included in the data stored by the integrated circuit is marked, in the information, as valid for the event ID associated with the event and when it is determined that the data stored by the integrated circuit does not include the indication that the ticket is used.

12. The computer program product of claim 1, wherein the data stored by the integrated circuit is a seed value personalized for the ICC.

13. The computer program product of claim 12, wherein the information stored remotely from the ICC includes a plurality of identifiers of a plurality of tickets stored remotely from the ICC in response to users purchasing the plurality of the tickets.

14. The computer program product of claim 13, wherein the plurality of identifiers of the plurality of tickets are generated using seed values personalized for ICCs of the respective users.

15. The computer program product of claim 13, wherein verifying whether the ICC is associated with the valid ticket, based on the data and the information stored remotely from the ICC, includes:
determining whether one of the plurality of identifiers of the plurality of tickets included in the information stored remotely from the ICC is associated with the seed value personalized for the ICC;
verifying that the ICC is associated with the valid ticket when it is determined that one of the plurality of identifiers of the plurality of event tickets included in the information stored remotely from the ICC is associated with the seed value personalized for the ICC; and
verifying that the ICC is not associated with the valid ticket when it is determined that the seed value personalized for the ICC is not associated with any of the plurality of identifiers of the plurality of event tickets included in the information stored remotely from the ICC.

16. The computer program product of claim 1, wherein the event ticket is authorized for entry to an associated event when it is verified that the ICC is associated with the valid ticket.

17. The computer program product of claim 1, wherein the additional data indicative of the authorization is stored on the ICC when the ticket is authorized, and further wherein the additional data indicative of the authorization includes a mark indicating that the ticket is used.

18. A method, comprising:
identifying data stored by an integrated circuit of an integrated circuit card (ICC);
verifying whether the ICC is associated with a valid ticket, based on the data and information stored remotely from the ICC, utilizing a processor;
authorizing the ticket for entry, based on the verification; and
based on the authorization, storing on the ICC additional data indicative of the authorization.

19. A system, comprising:
at least one processor for:
identifying data stored by an integrated circuit of an integrated circuit card (ICC);
verifying whether the ICC is associated with a valid ticket, based on the data and information stored remotely from the ICC;
authorizing the ticket for entry, based on the verification; and
based on the authorization, storing on the ICC additional data indicative of the authorization.

20. The system of claim 19, wherein the processor is coupled to memory via a bus.
